(19) United States
(12) Patent Application Publication
(10) Pub. No.: US 2013/0201696 A1
(43) Pub. Date: Aug. 8, 2013

(54) BULB-SHAPED LAMP AND LIGHTING DEVICE

(71) Applicants: Takeshi Hisayasu, Yokosuka (JP); Hiroshi Matsushita, Yokosuka (JP)

(72) Inventors: Takeshi Hisayasu, Yokosuka (JP); Hiroshi Matsushita, Yokosuka (JP)

(73) Assignee: Toshiba Lighting & Technology Corporation, Kanagawa (JP)

(21) Appl. No.: 13/814,435

(22) PCT Filed: Sep. 27, 2011
(86) PCT No.: PCT/JP2011/072120

§ 371 Date: Apr. 15, 2013

(30) Foreign Application Priority Data
Sep. 27, 2010 (JP) 2010-215985
Sep. 27, 2010 (JP) 2010-215986
Sep. 27, 2010 (JP) 2010-215987

(51) Int. Cl. F21V 29/00

(52) U.S. Cl. CPC F21V 29/004
USPC 362/363; 362/373

(57) ABSTRACT

A bulb-shaped lamp includes a housing which is formed of metal, and formed in a cylindrical shape which widely opens toward one end side using press molding. A case which is formed of a synthetic resin, and formed in a cylindrical shape which widely opens toward one end side along the inner surface of the housing is arranged in the housing. A base is attached to the other end side of the case. A heat radiating plate on which a light emitting module having a semiconductor light emitting element is mounted is arranged on one end side of the housing. A lighting circuit is accommodated in the case. The lighting circuit includes a lighting circuit board which is vertically arranged along the lamp axis direction in the case. The lighting circuit board is formed in a shape in which one end side becomes wide in width along the inner surface shape of the case, and is arranged at a position which is close to the base side in the case.

### TECHNICAL FIELD

Embodiments of the present invention relate to a bulb-shaped lamp in which a semiconductor light emitting element is used, and a lighting device in which the bulb-shaped lamp is used.

### BACKGROUND ART

In the related art, in a bulb-shaped lamp using a semiconductor light emitting element, a metal housing is included, a light emitting module having the semiconductor light emitting element on one end side of the housing is arranged, and a globe which covers the light emitting module is attached to one end of the housing. Further, the bulb-shaped lamp includes a case formed of a synthetic resin which is arranged in the housing, accommodates a lighting circuit in the case, and has a base which is attached to the other end of the case.

As the housing, a housing which is formed by aluminum die-casting which has an excellent heat radiation has been widely used, however, it may be a housing which is formed by press molding.

When the housing is formed by aluminum die-casting, usually radiating fins are provided on the periphery thereof, a cylindrical space having approximately the same diameter as that of the base is formed at the center portion of the housing by avoiding the radiating fins in the periphery, and the case and the lighting circuit are accommodated in the space. The lighting circuit includes a lighting circuit board which is vertically arranged along the axis direction of the lamp in the case, however, since the width of the lighting circuit board is limited to be small, the length of the lighting circuit board in the lamp axis direction is set to be large so as to secure a mounting area which is necessary for mounting components of the lighting circuit.

In addition, the bulb-shaped lamp of which the housing is formed using the press molding mounts the light emitting module on one end side surface of a metal heat radiating plate, and causes the heat radiating plate to come into contact with the housing, thereby radiating heat which is generated when lighting up the semiconductor light emitting element from the housing to the outside, by causing the heat to be thermally conducted to the housing from the heat radiating plate.

Even in such a bulb-shaped lamp of which the housing is formed using the press molding, since the lighting circuit is accommodated in a case with approximately the same diameter as that of the base and the width of the lighting circuit board is limited to be small, the length of the lighting circuit board in the lamp axis direction is set to be large so as to secure amounting area which is necessary for mounting the components of the lighting circuit. When the length of the lighting circuit board in the lamp axis direction is large in this manner, since the lighting circuit board and the heat radiating plate come close and it is not possible to establish an insulating distance which is necessary between the lighting circuit board and the heat radiating plate, an insulating member is interposed between the lighting circuit board and the heat radiating plate.

### CITATION LIST

### Patent Literature

[PTL 1] Japanese Laid-Open Patent Publication No. 2009-4130

[PTL 2] Japanese Registered Utility Model No. 3159084

### SUMMARY OF INVENTION

### Technical Problem

In a bulb-shaped lamp in the related art, the length of a lighting circuit board in the lamp axis direction is large, a lighting circuit board and a heat radiating plate are close to each other, and as a result, it is not possible to establish an insulating distance which is necessary between the lighting circuit board and the heat radiating plate, and it is necessary to interpose an insulating member between the lighting circuit board and the heat radiating plate, there is a problem in that a structure becomes complicated, or the number of components increases.

In particular, the bulb-shaped lamp of which a housing is formed by press molding has a large space compared to a housing which is formed by aluminum die-casting, however, the space has not been effectively used even though it is possible to make a space in the housing large.

The present invention was made in consideration of such a problem, and an object of the present invention is to provide a bulb-shaped lamp in which a necessary insulating distance is established without interposing an insulating member between a lighting circuit board and a heat radiating plate, and a lighting device in which the bulb-shaped lamp is used.

### Solution to Problem

The bulb-shaped lamp according to the embodiment includes a metal housing which is formed in a cylindrical shape which is widely open toward one end side using press molding. A synthetic resin case which is formed in a cylindrical shape which is widely open toward one end side is arranged in the housing along the inner surface of the housing. A base is attached to the other end side of the case. A heat radiating plate on which a light emitting module including a semiconductor light emitting element is mounted is arranged on one end side of the housing. A lighting circuit is accommodated in the case. The lighting circuit has a lighting circuit board which is vertically arranged in the case in the lamp axis direction. The lighting circuit board is formed in a shape in which one end side thereof becomes wide in width along the inner shape of the case, and is arranged at a position which is close to the base in the case.

### BRIEF DESCRIPTION OF DRAWINGS

FIG. 1 is a perspective view of a cross section of a bulb-shaped lamp according to an embodiment.

FIG. 2 is a perspective view of a disassembled state of the bulb-shaped lamp.

FIG. 3 illustrates a part of an attaching structure of a case of the bulb-shaped lamp and a globe, in which FIG. 3(a) is a perspective view of a state before attaching, and FIG. 3(b) is a perspective view of an attached state.

FIG. 4 illustrates a lighting device in which the bulb-shaped lamp is used.

### DESCRIPTION OF EMBODIMENTS

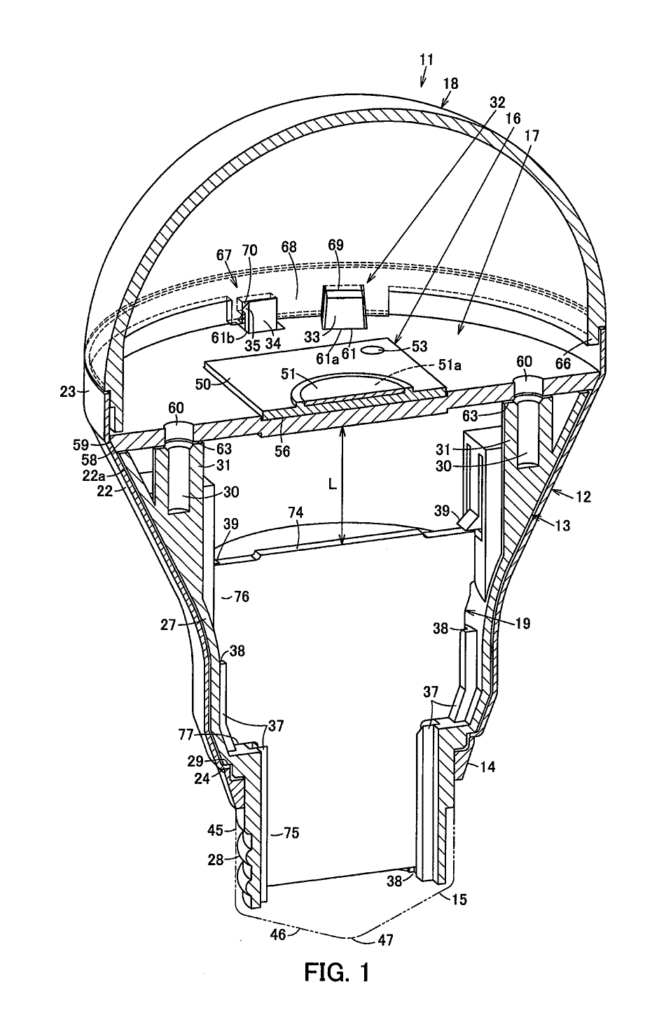

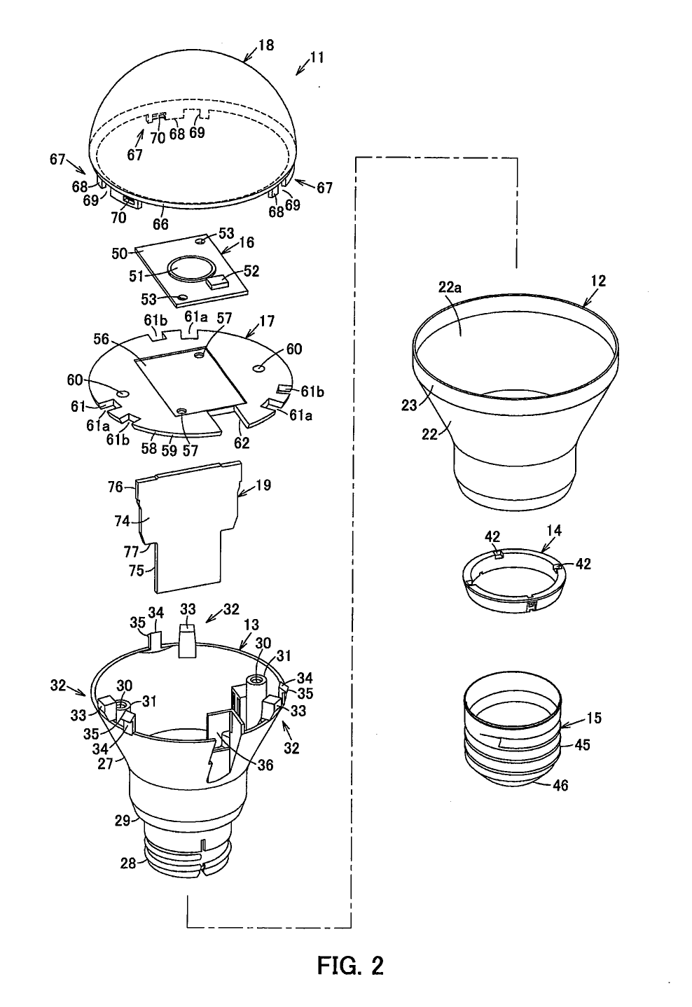

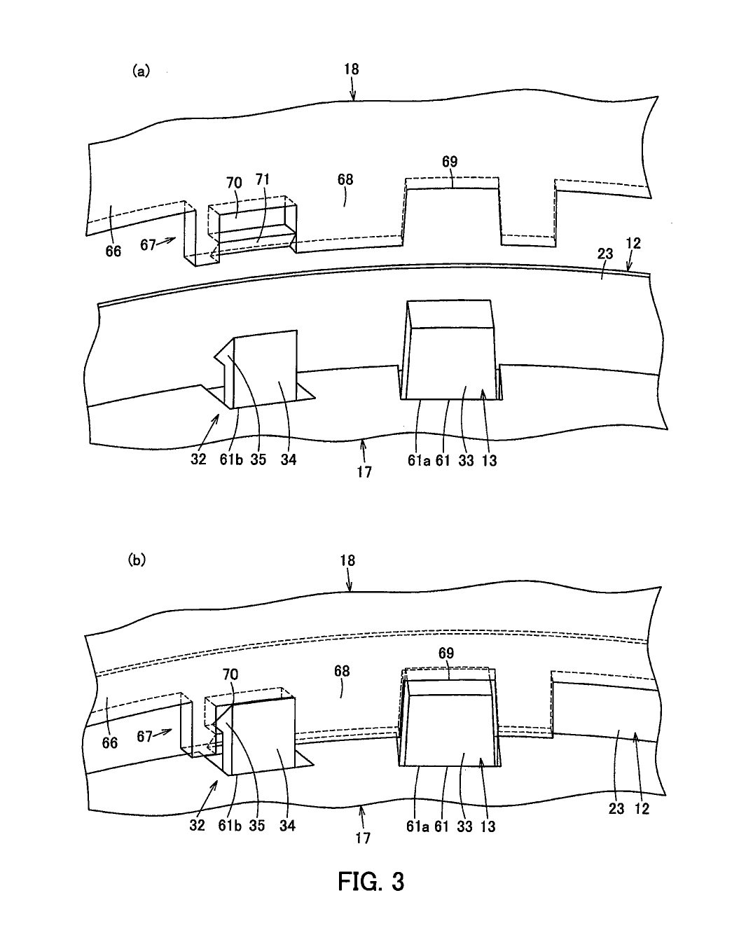

Hereinafter, an embodiment will be described with reference to FIGS. 1 to 4.

In FIGS. 1 to 4, 11 denotes a bulb-shaped lamp, and the bulb-shaped lamp 11 includes: a cylindrical housing 12; a case 13 which is arranged in the housing 12 by being inserted from one end side (one end side in a lamp axis direction in which a globe 18 of the bulb-shaped lamp 11 and base 15 are connected), and the other end is protruded from the housing 12; a ring 14 which fixes the other end of the case 13 to the housing 12, the base 15 which is attached to the other end of the case 13; a light emitting module 16 which is arranged on one end side of the housing 12 and case 13; a heat radiating plate 17 which is attached to one end side of the case 13 by mounting the light emitting module 16 on one end side surface, the globe 18 which is fitted into one end side of the housing 12, and is attached to one end side of the case 13; and a lighting circuit 19 which is arranged in the case 13. In addition, the bulb-shaped lamp 11 is formed in a shape almost close to an incandescent light bulb as a whole by having the same length in the lamp axis direction, and the same outer diameter at a portion with a maximum diameter in the direction intersecting the lamp axis direction as those in an incandescent light bulb for general illumination.

In addition, the housing 12 is formed of metal with excellent heat conductivity and heat radiation, and is formed in a cylindrical shape in which its diameter increases toward one end side from the other end side by press molding. In the housing 12, a cylindrical tapered portion 22 which expands in diameter toward one end side from the other end side is formed, a cylinder portion 23 which is parallel to the lamp axis is formed at one end of the tapered portion 22, and an engagement unit 24 which is bent toward the center side of the lamp axis is formed at the other end thereof. A tapered surface 22a which widely opens to one end side is formed on the inner surface of the tapered portion 22. A plurality of notch portions (not shown) which are used for positioning the case 13 are formed in the engagement unit 24.

In addition, both ends of the case 13 in the lamp axis direction are open using, for example, a synthetic resin having insulating property such as PBT resin, and the case is formed in a cylindrical shape which widely opens toward one end side. In the case 13, a case main body 27 which is arranged along the inner side of the housing 12, a base attaching portion 28 which protrudes from the other end side of the housing 12, and a step portion 29 which is engaged with the engagement unit 24 of the housing 12 between the case main body 27 and the base attaching portion 28 are formed.

The case main body 27 is formed in a tapered shape which widely opens toward one end side in the lamp axis direction, and becomes a similar shape to the inner surface shape of the housing 12 so as to be arranged along the tapered surface 22a on the inner surface of the tapered portion 22 of the housing 12. That is, the inner surface of the case main body 27 is formed as a tapered surface which widely opens toward the one end side.

A plurality of bosses 31 having a mounting hole 30 for screwing up a heat radiating plate 17 are formed on the inner surface on one end side of the case main body 27 along the lamp axis direction. According to the embodiment, the bosses 31 are formed at two portions which are symmetric to the center of the case main body 27, however, the bosses may be formed at three portions without being limited to two.

A plurality of globe attaching units 32 for attaching the globe 18 are formed at one end of the case main body 27. According to the embodiment, the globe attaching units 32 are formed at three portions at regular intervals in the circumferential direction at one end of the case main body 27, however, the globe attaching units maybe formed at two portions, or four portions or more without being limited to three portions. Each of the globe attaching units 32 has a positioning protrusion 33 which protrudes from the case main body 27 in one end direction, and a locking claw 34, respectively. The positioning protrusion 33 is formed in a tapered shape in which the width on the tip end side becomes narrow, and has a larger protruding dimension to one end direction than that of the locking claw 34. The locking claw 34 is formed with a claw 35 which protrudes toward the outer diameter direction at the tip end thereof. In addition, a wiring guide 36 is formed at one portion of one end of the case main body 27.

A pair of board holding units 37 for holding a lighting circuit board 74 of a lighting circuit 19 faces to each other, and is formed along the lamp axis direction across the inner surface of the base attaching portion 28 from the inner surface of the case main body 27 of the case 13. The pair of board holding units 37 is formed at a position which is offset from the center of the case 13 as one side position of each of bosses 31 which is formed at two portions which are symmetric to the center of the case main body 27. In each of the board holding units 37, a holding groove 38 to which the lighting circuit board 74 of the lighting circuit 19 is inserted is formed along the lamp axis direction. A locking unit 39 which locks the lighting circuit board 74 of the lighting circuit 19 which is inserted into the board holding units 37 is formed on one end side of each of the board holding units 37. The locking unit 39 is configured by a hook of which one end side is connected to the case 13, and of which the other end side is a free end.

A plurality of protrusions (not shown) which are fitted into each notch portion of the engagement unit 24 of the housing 12, and position a position in the circumferential direction are formed on the step portion 29.

In addition, the ring 14 is formed of a synthetic resin having an insulating property such as PBT resin, for example, insulates the housing 12 and the base 15 therebetween by being interposed therebetween, and interposes the engagement unit 24 of the housing 12 between the ring and the step portion 29 of the case 13. A plurality of concave portions 42 which position a position in the circumferential direction by being fitted into each protrusion of the case 13 are formed in the ring 14.

In addition, the base 15 can be connected to a socket for an E26 light bulb for general illumination, and includes a shell 45 which is fixed by being screwed to the circumferential surface of the base attaching portion 28 of the case 13, an insulating unit 46 which is provided on the other end side of the shell 45, and an eyelet 47 which is provided at an apex of the insulating unit 46.

In addition, a light emitting module 16 includes a rectangular plate-shaped board (module board) 50 which is formed of, for example, metal such as aluminum having excellent heat conductivity, or ceramics, a surface light source 51 as a light source which is formed in the center area of one surface as one end side surface of the board 50, and a connector 52 which is mounted in the periphery of one surface of the board 50.

In the surface light source 51, a semiconductor light emitting element 51a such as an LED element, or an EL element, for example, having a surface-shaped light emitting surface of φ2 mm or more is used. According to the embodiment, the LED element is used as the semiconductor light emitting element 51a, and a COB (Chip On Board) method in which the plurality of LED elements are mounted on the board 50 is adopted. That is, the plurality of LED elements are mounted on the board 50, these plurality of LED elements are electrically connected in series using wiring bonding, and the plurality of LED elements are integrally covered by a phosphor layer which is formed of a transparent resin such as a silicon resin, for example, in which phosphor is mixed. In the LED element, for example, an LED element which emits a blue light is used, and phosphor which radiates a yellow light which is excited by a part of the blue light from the LED element is mixed into the phosphor layer. Accordingly, the surface light source 51 is configured by the LED element, the phosphor layer, or the like, the surface of the phosphor layer as the surface of the surface light source 51 becomes the light emitting surface, and illumination light of a white system is radiated from the light emitting surface.

A wiring pattern which is not shown is formed on one surface of the board 50, and the plurality of LED elements, and the connector 52 are connected to the wiring pattern. A plurality of through holes 53 for being screwed to the heat radiating plate 17 are formed in the periphery of the board 50.

In addition, the heat radiating plate 17 is formed in a flat disk shape using metal, for example, aluminum or the like, which has excellent heat conductivity, or ceramics. A concave portion 56 into which the other surface side of the board 50 of the light emitting module 16 is fitted is formed on one surface of the heat radiating plate 17, and a plurality of mounting holes 57 which screw up the board 50 through each through hole 53 of the board 50 are formed in the concave portion 56.

A tapered surface 59 which is inclined at the same angle as the tapered surface 22a in the inner surface of the tapered portion 22 of the housing 12, and makes a surface contact with the tapered surface 22a from the inside of the housing 12 is formed on the thick end surface of plate 58 in the periphery of the heat radiating plate 17.

A plurality of through holes 60 through which screws which are screwed into each boss 31 are inserted are formed corresponding to positions of each of bosses 31 of the case 13 in the vicinity of the periphery of the heat radiating plate 17.

A plurality of notch portions 61 through which each globe attaching unit 32 of the case 13 passes on one end side are formed in the periphery of the heat radiating plate 17. Each of the notch portions 61 includes a notch portion 61a through which the positioning protrusion 33 passes, and a notch portion 61b through which the locking claw 34 passes. In addition, a notch portion 62 for wiring is formed in the periphery of the heat radiating plate 17 corresponding to a position of the wiring guide 36 of the case 13.

In an assembled state of the bulb-shaped lamp 11, it is configured so that a gap 63 is formed between the other surface of the heat radiating plate 17 and one end of the case main body 27 of the case 13, the housing 12, the case 13, the ring 14, and the base 15 are integrally assembled, and further, in an assembled state in which the heat radiating plate 17 is fitted from one end side of the housing 12, and the tapered surface 59 of the heat radiating plate 17 is caused to make a surface contact with the tapered surface 22a of the housing 12, the gap 63 is formed between the other surface of the heat radiating plate 17 and one end of the case main body 27 of the case 13.

In addition, the globe 18 is formed in a dome shape which is open to the other end side in the lamp axis direction, using a material such as a synthetic resin having transmittance and a light diffusion property, or glass, for example. A cylindrical fitting portion 66 which is fitted in parallel into the inner side of the cylinder portion 23 of the housing 12 is formed in a protruding manner at an opening edge portion of the other end side of the globe 18. The fitting portion 66 is formed in a cylindrical shape which is continuous in the circumferential direction without breaking or the like.

A plurality of case attaching portions 67 which are attached to each globe attaching unit 32 of the case 13 are formed at the other end of the fitting portion 66. A wall portion 68 which protrudes to the other end side from the fitting portion 66 is formed in each case attaching portion 67, the groove portion 69 to which the positioning protrusion 33 is fitted is formed on the wall portion 68, and a locking hole 70 at which the claw 35 of the locking claw 34 is hooked by being fitted from the inner surface side of the wall portion 68 is formed. Both side surfaces in the groove portion 69 are inclined so as to widely open to the other end side in order to be fitted to both the side surfaces of the tapered positioning protrusion 33. A guiding groove 71 which guides the claw 35 of the locking claw 34 to the locking hole 70 is formed at the tip end of the wall portion 68. In addition, in the groove portion 69 and the locking hole 70, positions thereof in the lamp axis direction are regulated when the inner surface of the groove portion 69 comes into contact with the surface of the tip end of the positioning protrusion 33, and a positional relationship in which the claw 35 of the locking claw 34 is fitted to the locking hole 70 is formed in an attaching state of the globe 18 in which both side surfaces in the groove portion 69 comes into contact with both side surfaces of the positioning protrusion 33, and are regulated in position in the circumferential direction. In the attaching state of the globe 18, the tip end of the wall portion 68 is alienated from one surface of the heat radiating plate 17 without being in contact.

In addition, the lighting circuit 19 is a circuit which supplies a constant current to the LED element of the light emitting module 16, and includes the lighting circuit board 74 and a plurality of components of the lighting circuit (not shown) which are mounted on the lighting circuit board 74.

The lighting circuit board 74 has one surface as a mounting surface on which main components of the lighting circuit are mounted, and another surface as a wiring pattern surface on which a wiring pattern is formed to which the lighting circuit components are electrically connected.

The lighting circuit board 74 is inserted from one end side of the case 13, and is held when both sides of the lighting circuit board 74 are fitted into the holding groove 38 of the board holding unit 37. Accordingly, the lighting circuit board 74 is vertically arranged along the lamp axis direction in the case 13, and is arranged at an offset position from the center of the case 13 so that the distance between the mounting surface and the inner surface of the case 13 becomes wider than the distance between the wiring pattern surface and the inner surface of the case 13.

The lighting circuit board 74 has a shape in which the width on one end side becomes wide along the inner surface shape of the case 13. That is, a narrow width portion 75 which is arranged in the base attaching portion 28 of the case 13 is formed on the other end side of the lighting circuit board 74, and a wide width portion 76 which is arranged in the case main body 27 of the case 13, has a wider width than the other end side, and becomes wide in width toward one end side is formed on one end side of the lighting circuit board 74. A regulation unit 77 which positions an insertion position into the case 13 by being in contact with the case 13 is formed between the narrow width portion 75 and the wide width portion 76.

In this manner, since it is possible to make the mounting area of the lighting circuit board 74 wide by forming the one end side of the lighting circuit board 74 to be wide in width, it is possible to make the length of the lighting circuit board 74 in the lamp axis direction small while securing a mounting area which is necessary for mounting the components of the lighting circuit. In this manner, the lighting circuit board 74 is arranged at a position which is close to the base 15 side in the case 13, and it is possible to secure a necessary insulating distance L without interposing an insulating member between the lighting circuit board 74, the components of the lighting circuit and the heat radiating plate 17.

The plurality of components of the lighting circuit as discrete components having lead wires are mounted on the mounting surface of the lighting circuit board 74. The lead wire of these components of the lighting circuit penetrates the lighting circuit board 74, and is connected to the wiring pattern on the wiring pattern surface using soldering. As the components of the lighting circuit which are mounted on the mounting surface of the lighting circuit board 74, an electrolytic capacitor of a rectification smoothing circuit which rectifies and smoothes an AC voltage, and an inductor of a chopper circuit which converts a rectified and smoothed voltage to a predetermined voltage are included, and in addition to those, a large component such as a resistor which is used in the circuit, or small components such as a switching element, a capacitor, a diode, and the like of the chopper circuit are also included in addition to those. Among the components of the lighting circuit which are mounted on the mounting surface of the lighting circuit board 74, the larger components are arranged at one end side of which the inside diameter of the case 13 becomes large, and the smaller components are arranged at the other end side of which the inside diameter of the case 13 becomes small.

Among the components of the lighting circuit, surface mounted components are subject to surface mount on the wiring pattern surface of the lighting circuit board 74. As the surface mounted components, a chip resistor, a chip capacitor, and the like are included.

On the input side of the lighting circuit 19, an input lead wire (not shown) is electrically connected to the shell 45 and the eyelet 47 of the base 15, respectively, through the other end opening of the case 13. In addition, an output lead wire having a connector which is not shown connected to the connector 52 of the light emitting module 16 is connected to the output side of the lighting circuit 19.

In addition, when assembling the bulb-shaped lamp 11, the lighting circuit 19 is inserted into the case 13 from one end side of the case 13. At this time, when both sides of the lighting circuit board 74 are inserted into the holding groove 38 of the board holding units 37 of the case 13, both sides of the lighting circuit board 74 come into contact with the locking units 39 on both sides, and these locking units 39 are elastically deformed outward, and then, when the regulation unit 77 of the lighting circuit board 74 comes into contact with the case 13, and is inserted into a predetermined attaching position at which the insertion is regulated, the lighting circuit board 74 goes on to the locking unit 39, the locking unit 39 is hooked at one end side of the lighting circuit board 74, and the lighting circuit 19 is locked and held in the case 13. The output lead wire of the lighting circuit 19 is drawn outside the case 13 through a wiring guide 36 of the case 13.

The case 13 is inserted from one end side of the housing 12, the base attaching portion 28 of the case 13 is protruded from the other end of the housing 12, the ring 14 is fitted into the outer periphery of the base attaching portion 28 of the case 13, and the base 15 is attached by being screwed. At this time, the input lead wire on one side of the lighting circuit 19 is connected to the eyelet 47 of the base 15, and the other lead wire is connected to the shell 45 of the base 15 which is arranged in the outer periphery of the base attaching portion 28 of the case 13, and is attached to the base attaching portion 28 by being screwed.

When inserting the case 13 into the housing 12, the plurality of protrusions which are provided at the step portion 29 of the case 13 and the plurality of notch portions which are provided at the engagement unit 24 of the housing 12 are fitted to each other, and the case 13 and the housing 12 are prevented from being rotated.

In this manner, by attaching the base 15 to the base attaching portion 28 of the case 13, the housing 12, the case 13 in which the lighting circuit 19 is assembled, the ring 14, and the base 15 are integrally assembled.

Subsequently, the heat radiating plate 17 is fitted to one end side of the housing 12 while causing the positioning protrusion 33 and the locking claw 34 which are protruded from one end of the case 13 to pass through each of the notch portions 61a and 61b in the periphery of the heat radiating plate 17. In this manner, the tapered surface 59 of the thick end surface of plate 58 of the heat radiating plate 17 makes a surface contact with the tapered surface 22a in the inner surface of the tapered portion 22 from inside the housing 12. In this state, circumferential positions of the heat radiating plate 17 and case 13 are positioned by causing the positioning protrusion 33 and the locking claw 34 of the case 13 to pass through the notch portions 61a and 61b of the heat radiating plate 17, each through hole 60 of the heat radiating plate 17 matches the mounting hole 30 of the boss 31 of the case 13, and further, a position of the notch portion 62 for wiring of the heat radiating plate 17 matches a position of the wiring guide 36 of the case 13. In addition, in this state, the gap 63 occurs between the other surface of the heat radiating plate 17 and one end of the case main body 27 of the case 13.

A screw is screwed to the mounting hole 30 of the boss 31 of the case 13 from the through hole 60 of the heat radiating plate 17, and the heat radiating plate 17 is fixed to the case 13 by being tightened using the screw. At this time, since there is the gap 63 between the other surface of the heat radiating plate 17 and one end of the case main body 27 of the case 13, a tightening force using the screw is added to the bonding surface of the tapered surface 59 of the thick end surface of plate 58 of the heat radiating plate 17, and the tapered surface 22a of the tapered portion 22 of the housing 12, and the tapered surface 59 of the thick end surface of plate 58 of the heat radiating plate 17 comes into press contact with the tapered surface 22a of the tapered portion 22 of the housing 12, thereby securing good heat conductivity. In addition, a silicon resin may be interposed between the tapered surface 59 of the thick end surface of plate 58 of the heat radiating plate 17 and the tapered surface 22a of the tapered portion 22 of the housing 12 so as to make the heat conductivity uniform.

The light emitting module 16 is arranged in the concave portion 56 of the heat radiating plate 17, and is screwed on. In addition, the light emitting module 16 may be attached to the heat radiating plate 17 in advance, before attaching the heat radiating plate 17 to the case 13.

The output lead wire of the lighting circuit 19 is drawn to one surface of the heat radiating plate 17 through the notch portion 62 of the heat radiating plate 17, and a connector on the tip end of the lead wire is connected to the connector 52 of the light emitting module 16.

An adhesive such as a silicon resin or cement is applied to the inner periphery of the cylinder portion 23 of the housing 12, and each case attaching portion 67 of the globe 18 is aligned to a position of each globe attaching unit 32 of the case 13 which is protruded from the heat radiating plate 17, and the fitting portion 66 of the globe 18 is fitted inside the cylinder portion 23 of the housing 12.

At this time, first, the wall portion 68 of each of the case attaching portion 67 of the globe 18 is fitted inside the cylinder portion 23 of the housing 12, and a position of the globe 18 and the housing 12 in the radial direction as the center of the lamp axis is determined. Each positioning protrusion 33 of the case 13 is fitted into the groove portion 69 of each of the case attaching portions 67, and the position in the circumferential direction of the globe 18 and the housing 12 is determined, by adjusting a position of the globe 18 with respect to the housing 12 by rotating the globe 18 as necessary, thereafter, and due to this, positions of each of the locking hole 70 of the globe 18, and positions of each of the locking claw 34 of the case 13 are positioned. Thereafter, the fitting portion 66 of the globe 18 is fitted into the inner periphery of the cylinder portion 23 of the housing 12, the surface on the depth side of each groove portion 69 of the globe 18 comes into contact with the tip end surface of each positioning protrusion 33 of the case 13, thereby regulating the position in the lamp axis direction, and the globe 18 is attached to the case 13 when the claw 35 of the locking claw 34 of the case 13 is fitted into each locking hole 70 of the globe 18.

In the attached state of the globe 18, the tip end of the wall portion 68 of the globe 18 is alienated without being in contact with one surface of the heat radiating plate 17, the globe 18 is alienated from the cylinder portion 23 of the housing 12 without being in contact with one end thereof, and the globe 18 is supported by the case 13. Further, the position in the lamp axis direction is determined when the surface on the depth side in the groove portion 69 of the globe 18 comes in contact with the tip end surface of each positioning protrusion 33 of the case 13, and the position in the circumferential direction is determined when the claw 35 of the locking claw 34 of the case 13 is hooked at the locking hole 70 of the globe 18, and is held, and both side surfaces in the groove portion 69 of the globe 18 come into contact with both side surfaces of the positioning protrusion 33 of the case 13. Accordingly, the globe 18 is attached in a state where the position is determined with respect to the case 13.

In addition, the assembling order of the bulb-shaped lamp 11 is not limited to this, and may be a different attaching order.

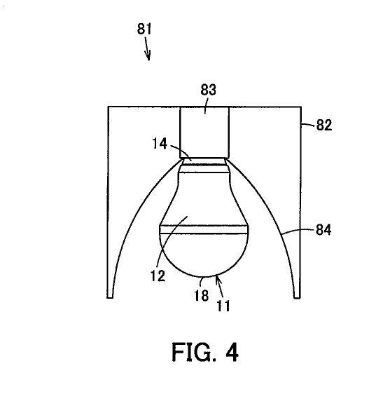

In addition, FIG. 4 illustrates a lighting device 81 as a downlight in which the bulb-shaped lamp 11 is used, and the lighting device 81 includes a device main body 82, and a socket in which the bulb-shaped lamp 11 is installed, and a reflector 84 which causes light which is radiated from the bulb-shaped lamp 11 to be reflected downward are arranged in the device main body 82.

In addition, when the bulb-shaped lamp 11 is electrically connected by being installed in the socket 83 of the lighting device 81, the lighting circuit 19 is operated, power is supplied to a plurality of LED chips of the light emitting module 16, light is radiated from the surface light source 51 when the plurality of LED chips are turned on, and the light which is radiated from the surface light source 51 transmits the globe 18, and is radiated to the outside.

The heat which is generated at the time of turning on of the plurality of LED chips of the light emitting module 16 is mainly conducted to the board 50, is conducted to the heat radiating plate 17 from the board 50, is further conducted to the housing 12 from the heat radiating plate 17, and is radiated to the air from the surface of the housing 12.

In addition, according to the bulb-shaped lamp 11 of the embodiment, since the globe 18 is attached to the case 13 of synthetic resin which can be formed with high precision, not to the housing 12 which is press molded, it is possible to make the attaching position of the globe 18 uniform without a difficulty of attaching the globe 18 even when the press molded housing 12 is used.

In addition, it is possible to attach the globe 18 to the case 13 by causing the globe attaching unit 32 of the case 13 to be protruded to one end side by penetrating the heat radiating plate 17.

It is possible to respectively determine positions in the lamp axis direction and the circumferential direction between the globe 18 and the case 13 using the positioning protrusion 33 which is provided as the globe attaching unit 32.

It is possible to lock the globe 18 and the case 13 in a state in which the positions between the globe 18 and the case 13 using the positioning protrusion 33 are determined, using the locking claw 34 which is provided as the globe attaching unit 32.

In addition, the cylinder portion 23 at one end of the housing 12 is easily deformed by external force, however, since the fitting portion 66 of the globe 18 is fitted inside the cylinder portion 23 of the housing 12 in parallel, even when a shock is applied in the vicinity of the cylinder portion 23 of the housing 12 due to a fall or the like of the bulb-shaped lamp 11 at the time of handling, it is possible to prevent the deformation from occurring in the cylinder portion 23 of the housing 12. In particular, since the fitting portion 66 of the globe 18 is formed in a cylinder shape which is continuous in the circumferential direction without breaking, it is possible to reliably prevent the deformation from occurring in the cylinder portion 23 in the whole circumference of the cylinder portion 23 of the housing 12.

In addition, since the tapered surface 59 which is formed on the thick end surface of plate 58 in the periphery of the heat radiating plate 17 on which the light emitting module 16 is mounted is caused to make a surface contact with the tapered surface 22a of the tapered portion 22 of the housing 12 from the inside of the housing 12, it is possible to reliably secure good heat conductivity to the housing 12 from the heat radiating plate 17 even when the press molded housing 12 is formed to be a shape similar to the bulb shape.

It is possible to make the globe attaching unit 32 of the case 13 to protrude to one end side by penetrating the heat radiating plate 17 by providing the notch portion 61 in the periphery of the heat radiating plate 17.

In addition, the case 13 which is formed of the synthetic resin, and is formed in a cylindrical shape which widely opens toward one end side along the inner surface of the housing 12 is arranged in the housing 12 which is formed of metal, and is formed in the cylindrical shape which widely opens toward one end side using the press molding. Further, by forming the lighting circuit board 74 which is vertically arranged along the lamp axis direction in the case 13 so as to have a shape of which one end side becomes wide in width along the inner surface shape of the case 13, it is possible to make the length in the lamp axis direction of the lighting circuit board 74 small while securing a mounting area which is necessary for mounting the components of the lighting circuit on the lighting circuit board 74. In this manner, it is possible to arrange the lighting circuit board 74 at a position which is close to the base 15 side in the case 13, and to secure the necessary insulating distance L without interposing an insulating member between the lighting circuit board 74 and the heat radiating plate 17 by causing the lighting circuit board 74 to alienate from the heat radiating plate 17, accordingly, it is possible to make the structure of the bulb-shaped lamp 11 simple, and to reduce the number of components.

Since the board holding unit 37 into which both side portions of the lighting circuit board 74 are inserted from one end side is provided, and the locking unit 39 for locking one end of the lighting circuit board 74 which is inserted into the board holding unit 37 is provided in the inner surface of the case 13, it is possible to arrange the lighting circuit board 74 at a position which is close to the base 15 side in the case 13, and hold thereto.

In addition, the embodiment can also be applied to a bulb-shaped lamp of a size of the mini-krypton light bulb in which the E17 base is used.

While several embodiments have been described, these embodiments have been presented by way of example only, and are not intended to limit the scope of the inventions. These novel embodiments may be embodied in a variety of other forms. Various omissions, substitutions, and changes in the form of the embodiments described herein may be made without departing from the spirit of the inventions. These embodiments and the modifications thereof are included in the scope and the spirit of the inventions and included in the inventions described in patent claims and the scope of equivalents of the inventions.

### REFERENCE SIGNS LIST

11: BULB-SHAPED LAMP
12: HOUSING
13: CASE
15: BASE
16: LIGHT EMITTING MODULE
17: HEAT RADIATING PLATE
18: GLOBE
19: LIGHTING CIRCUIT
22: TAPERED PORTION
32: GLOBE ATTACHING UNIT
37: BOARD HOLDING UNIT
39: LOCKING UNIT
51a: SEMICONDUCTOR LIGHT EMITTING ELEMENT
58: THICK END SURFACE OF PLATE
59: TAPERED SURFACE
61: NOTCH PORTION
74: LIGHTING CIRCUIT BOARD
81: LIGHTING DEVICE
82: DEVICE MAIN BODY
83: SOCKET

1. A bulb-shaped lamp comprising:
a light emitting module which includes a semiconductor light emitting element;
a heat radiating plate on which the light emitting module is mounted on one end side;
a housing which is formed of metal, formed in a cylindrical shape which is widely open toward one end side using press molding, and is arranged with the heat radiating plate on one end side thereof;
a case which is arranged in the housing, formed of a synthetic resin, and formed in a cylindrical shape which is widely open toward one end side along the inner surface of the housing;
a base which is attached to the other end side of the case; and
a lighting circuit that has a lighting circuit board on which components of the lighting circuit are mounted, and which is vertically arranged along a lamp axis direction in the case, and in which the lighting circuit board is formed so as to have a shape of which one end side becomes wide in width along an inner surface shape of the case, and is arranged at a position which is close to the base side in the case.

2. The bulb-shaped lamp according to claim 1,
wherein a board holding unit into which both sides of the lighting circuit board are inserted from one end side is provided, and a locking unit which locks one end of the lighting circuit board which is inserted into the board holding units is provided in the inner surface of the case.

3. The bulb-shaped lamp according to claim 1,
wherein a globe which is attached to one end side of the case is included.

4. The bulb-shaped lamp according to claim 3,
wherein the case has a globe attaching unit which protrudes to one end side by penetrating the heat radiating plate, and to which the globe is attached.

5. The bulb-shaped lamp according to claim 4,
wherein a notch portion through which the globe attaching unit penetrates is provided in a periphery of the heat radiating plate.

6. The bulb-shaped lamp according to any one of claim 1,
wherein the housing includes a tapered portion which widely opens toward one end side, and
wherein the heat radiating plate is formed with a tapered surface which makes a surface contact with the tapered portion from the inside of the housing on a thick end surface of plate in the periphery, and the tapered surface is in press contact with the housing by being fixed to the case.

7. A lighting device comprising:
a device main body having a socket; and
the bulb-shaped lamp according to claim 1 which is mounted on the socket.
